(19) United States
(12) Patent Application Publication
(10) Pub. No.: US 2011/0029908 A1
(43) Pub. Date: Feb. 3, 2011

(54) PROCESS MANAGEMENT SYSTEM

(75) Inventor: JYH-GWO JU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/622,606

(22) Filed: Nov. 20, 2009

(30) Foreign Application Priority Data
Jul. 30, 2009 (CN) 200910304997.9

(51) Int. Cl. G06F 9/46; G06F 3/048

(52) U.S. Cl. 715/771; 718/100; 719/318

(57) ABSTRACT

A process management system includes a display, a process handling module and a plurality of window process modules. The window process modules communicate with the process handling module to start up or shut down the window process modules. Each window process module processes one function on the display. The window process module includes a common basic window module and a special window module. The common basic window module processes common basic window functions of the window process modules. The special window module implements special window functions of each window process module.

### BACKGROUND

1. Technical Field

The present disclosure relates to a process management system.

2. Description of Related Art

Embedded devices, for example, digital photo frames (DPFs) are becoming increasingly popular due to their convenience and ease of manipulation when implementing particular functions. However, if the embedded device has only one window application, all window functions (for example, video, photo) are integrated in the window application. Every time a user needs a window function (for example, looking through photos), the window application with all window functions is started up. The window application will consume more system resources.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a process management system.

FIG. 2 is a block view of a common basic window module.

FIG. 3 is a schematic view of a window process module.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

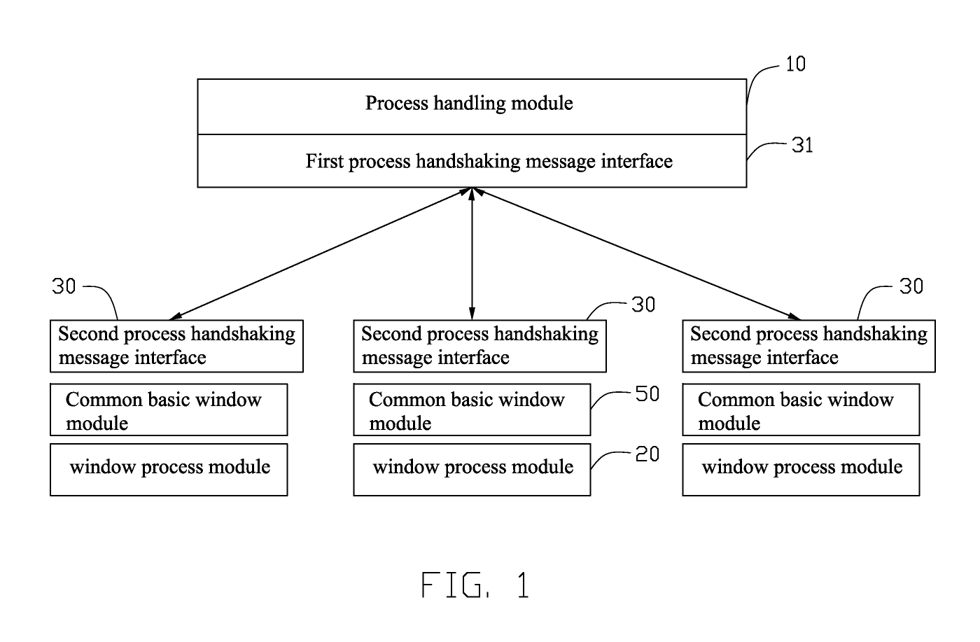

Referring to FIG. 1, a process management system includes a process handling module 10, a plurality of window process modules 20 and a display showing each window process module 20. The process handling module's first process handshaking message interface 31 to communicate with the window process module 20 based on a unified standardizing protocol. The process handling module's first process handshaking message interface 31 analyzes and handles messages from the window process modules 20. The messages have a special format being analyzed by the first process handshaking message interface 31. The first process handshaking message interface 31 of the process handling module 10 sends the messages to the window process module 20 according to the special format. The window process module's second process handshaking message interface 30 of the window process module 20 analyzes the messages from the process handling module 10 according to the special format. The process management system is set in an electronic device.

The first process handshaking message interface 31 of the process handling module 10 works with the second process handshaking message interface 30 of the window process module 20. The first process handshaking message interface 31 of the process handling module 10 sends the messages to the window process module 20 according to the special format. The second process handshaking message interface 30 of the window process module 20 analyzes the messages from the process handling module 10 according to the special format. The second process handshaking message interface 30 sends the messages to the process handling module 10 according to the special format. The first process handshaking message interface 31 analyzes the messages from the window process module 20 according to the special format.

The window process module 20 communicates with the process handling module 10 through the process handshaking message interface 30 and a common basic window module 50. The common basic window module provides a common basic function for the window process module 20. The window process module 20 may be a video window module, a photo window module, or a radio window module.

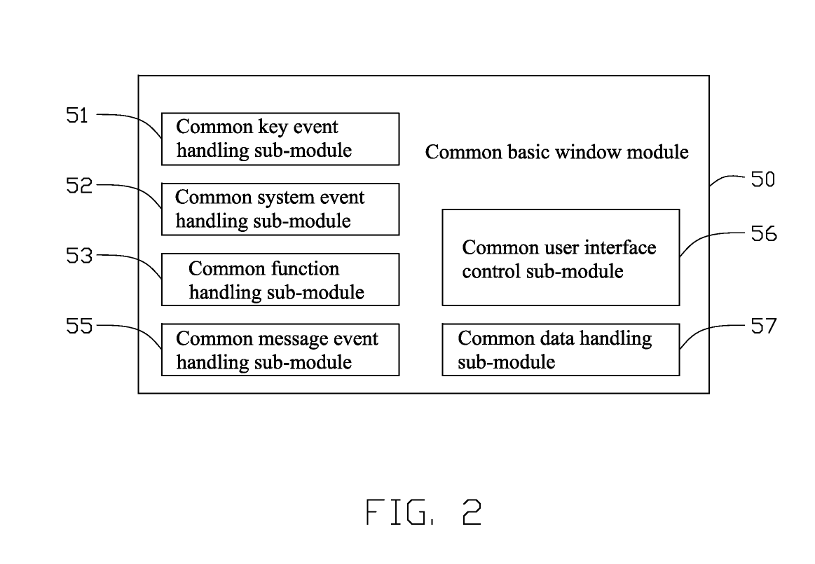

Referring to FIG. 2, the common basic window module 50 includes a common key event handling sub-module 51, a common system event handling sub-module 52, a common function handling sub-module 53, a common message event handling sub-module 55, a common user interface control sub-module 56, and a common data handling sub-module 57.

The common key event handling sub-module 51 handles common key events of the window process modules 20. For example, when a user controls the electronic device by a remote controller, all direction keys in the remote controller can control each window process module 20. All direction key events are handled by the common key event handling sub-module 51.

The common system event handling sub-module 52 monitors the window process module 20. The common system event handling sub-module 52 notifies the process handling module 10 to restart the window process module 20 when the window process module 20 is not running correctly.

The common function handling sub-module 53 manages some common functions of the window process modules 20, e.g. an alarm function, an idle function. When any window process module 20 is running, the alarm function can be started up in the electronic device. Each window process module 20 has the common functions. The common functions are handled by the common function handling sub-module 53.

The common message event handling sub-module 55 handles the common message events between the window process module 20 and the process handling module 10. For example, the process handling module 10 sends a check message to the window process module 20 so that the window process module 20 is running correctly. The window process module 20 sends a terminate request message to the process handling module 10 so that the process handling module 10 kills the window process module 20. These common message events can be handled by the common message event handling sub-module 55.

The common user interface control sub-module 56 controls the common user interface of the window process modules 20. For example, the common user interface is used for showing a logo of each window process module 20. The common user interface is used for showing a scroll bar of each window process module 20.

The common data handling sub-module 57 handles the common data of the window process modules 20. For example, a perpetual calendar window process module and a schedule window process module both need the common date data handled by the common data handling sub-module 57.

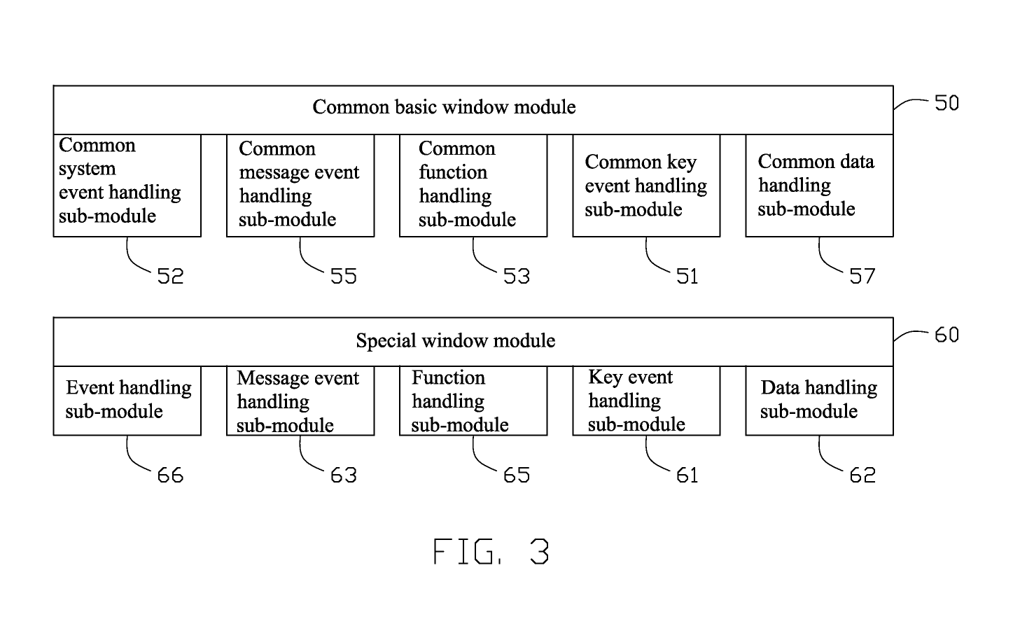

Referring to FIG. 3, the window process module 20 also includes a special window module 60 capable of handling special functions of the window process modules 20. The special window module 60 includes a key event handling sub-module 61 capable of handling a special key event of the window process module 20. For example, a video window process module can be controlled by a volume decrease button of the remote controller. But a photo window process module cannot be controlled by the volume down key of the remote controller. The key event handling sub-module 61 handles the volume down key event of the remote controller.

The special window module 60 includes a data handling sub-module 62 capable of handling special data of the window process module 20. For example, the perpetual calendar window process module includes more data information than other window process modules 20. The data handling sub-module 62 loads the special or exclusive data information to a display of the electronic device.

The special window module 60 includes a message event handling sub-module 63 capable of handling special message event of the window process module 20. The window process module 20 sends a special message to the process handling module 10. A special message event can be handled by the message event handling sub-module 63.

The special window module 60 includes a function handling sub-module 65 capable of handling a special function of the window process module 20. When the window process module 20 has a special function, the function handling sub-module 65 handles the special function to show on the display.

The special window module 60 includes an event handling sub-module 66 capable of handling special events of the window process module 20. When the window process module 20 has a special event to be handled, the event handling sub-module 66 handles the special event for the window process module 20.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A process management system, comprising:
a display;
a process handling module;
a plurality of window process modules capable of communicating with the process handling module to start up or shut down the window process modules, each window process module is capable of processing one function on the display, the window process module comprising a common basic window module and a special window module, the common basic window module being capable of processing common basic window functions of the window process modules, the special window module being capable of implementing special window functions of each window process module.

2. The process management system of claim 1, wherein the common basic window module comprises a common system event handling sub-module that is capable of monitoring the window process module and notifying the process handling module to restart when the window process module runs incorrectly.

3. The process management system of claim 1, wherein the common basic window module comprises a common user interface control sub-module capable of controlling a common user interface of the window process modules.

4. The process management system of claim 3, wherein the common user interface is capable of showing a logo of each window process module.

5. The process management system of claim 1, wherein each common basic window module comprises a common key event handling sub-module capable of handling a common key event from the window process modules.

6. The process management system of claim 5, wherein the common key event handling sub-module is capable of handling direction key events.

7. The process management system of claim 1, wherein each common basic window module comprises a common data handling sub-module capable of handling common data of the window process modules.

8. The process management system of claim 7, wherein the common data handling sub-module is capable of handling common date data of the window process modules.

9. The process management system of claim 1, wherein the common basic window module comprises a common message event handling sub-module capable of handling a common message event from the process handling module.

10. The process management system of claim 9, wherein the common message event handling sub-module is capable of handling an end request message from each window process module to the process handling module.

11. The process management system of claim 1, wherein the special window module comprises a key event handling sub-module capable of handling a special key event from one of the window process modules.

12. The process management system of claim 11, wherein the key event handling sub-module is capable of handling a volume down key event of the window process module.

13. The process management system of claim 1, wherein the special window module comprises a data handling sub-module capable of handling special data of the window process module.

14. The process management system of claim 13, wherein the window process module comprises a perpetual calendar window process module having the special data handled by the data handling sub-module.

15. The process management system of claim 1, wherein the special window module comprises a message event handling sub-module capable of handling special message event of the window process module.

16. The process management system of claim 1, wherein the special window module comprises a function handling sub-module capable of handling a special function of the window process module.

17. A process management system, comprising:
a display;
a process handling module;
a plurality of window process modules capable of communicating with the process handling module to start up or shut down the window process modules, each window process module is capable of processing one function on the display, the window process module comprising a common basic window module and a special window module, the common basic window module being capable of processing common basic window functions of the window process modules, the special window module being capable of implementing special window functions of each window process module, the common basic window module comprising a common function handling sub-module capable of handling common functions of the window process module to show the common functions on the display.

18. The process management system of claim 17, wherein the common basic window module comprises a common system event handling sub-module that is capable of monitoring the window process module and notifying the process handling module to restart when the window process module is running incorrectly.

19. The process management system of claim 17, wherein the common basic window module comprises a common user interface control sub-module capable of controlling a common user interface.

20. The process management system of claim 17, wherein the common basic window module comprises a common key event handling sub-module capable of handling a common key event of the window process modules.
